(19) United States
(12) Patent Application Publication
(10) Pub. No.: US 2018/0288156 A1
(43) Pub. Date: Oct. 4, 2018

(54) INFORMATION PROCESSING SYSTEM, INFORMATION PROCESSING METHOD, AND INFORMATION PROCESSING DEVICE THAT ENSURE DELETING ASSOCIATED DATA

(71) Applicant: KYOCERA Document Solutions Inc., Osaka (JP)

(72) Inventors: Shoichi SAKAGUCHI, Osaka (JP); Jiro NAGIRA, Osaka (JP); Tetsuya YOSHIOKA, Osaka (JP); Tetsuya NISHINO, Osaka (JP); Yoshiki YOSHIOKA, Osaka (JP); Yoshihisa TANAKA, Osaka (JP)

(73) Assignee: KYOCERA Document Solutions Inc., Osaka (JP)

(21) Appl. No.: 15/935,766

(22) Filed: Mar. 26, 2018

(30) Foreign Application Priority Data
Mar. 30, 2017 (JP) 2017-068326
Mar. 30, 2017 (JP) 2017-068329

(51) Int. Cl. H04L 29/08

(52) U.S. Cl. CPC H04L 67/1097; H04L 67/06

(57) ABSTRACT

An information processing system includes a server and an information processing device that includes an accepting unit, a communication control unit, a storage unit, and a storage control unit. The storage control unit causes the storage unit to store the data received by the communication unit from the server. The storage control unit performs processes to: (i) cause the communication unit to receive the associated information from the server in addition to the data when the communication unit is caused to receive the data from the server; and (ii) determine whether the storage unit stores data associated with one piece of data or not when the accepting unit accepts a deletion instruction of data specifying the one piece of data stored in the storage unit and delete the associated data from the storage unit together with the one piece of data when the storage unit stores the associated data.

### INCORPORATION BY REFERENCE

This application is based upon, and claims the benefit of priority from, corresponding Japanese Patent Application Nos. 2017-068326 and 2017-068329, each filed in the Japan Patent Office on Mar. 30, 2017, the entire contents of which are incorporated herein by reference.

### BACKGROUND

Unless otherwise indicated herein, the description in this section is not prior art to the claims in this application and is not admitted to be prior art by inclusion in this section.

Recently in offices, an intra-company network in which a server, an individually-used Personal Computer (PC), an image forming apparatus, and a similar device are connected to a network such as a Local Area Network (LAN) is established. Individuals can receive (download) desired data at the individual PCs through access to the server, thus achieving smooth data sharing and a similar operation inside the company.

### SUMMARY

An information processing system according to a first aspect of the disclosure includes a server and an information processing device. The server stores a plurality of pieces of data. The information processing device includes a communication unit configured to perform transmission and reception of data with the server. The server further stores associated information. The associated information is indicative of data mutually associated between the plurality of pieces of data. The information processing device further includes an accepting unit, a communication control unit, a storage unit, and a storage control unit. The accepting unit accepts an instruction from a user. The communication control unit controls a communication operation of the data by the communication unit. The communication control unit causes the communication unit to receive data specified by the instruction accepted by the accepting unit among the plurality of pieces of data stored in the server from the server. The storage control unit causes the storage unit to store the data received by the communication unit from the server. The storage control unit performs processes to: (i) cause the communication unit to receive the associated information from the server in addition to the data when the communication unit is caused to receive the data from the server; and (ii) determine whether the storage unit stores data associated with one piece of data or not when the accepting unit accepts a deletion instruction of data specifying the one piece of data stored in the storage unit and delete the associated data from the storage unit together with the one piece of data when the storage unit stores the associated data.

An information processing system according to a first aspect of the disclosure includes a server and a plurality of information processing devices. The server stores a plurality of pieces of data. The plurality of information processing devices include communication units configured to perform transmission and reception of data with the server. The plurality of information processing devices each further include an accepting unit, a communication control unit, a storage unit, and a storage control unit. The accepting unit accepts an instruction from a user. The communication control unit controls a communication operation of the data by the communication unit. The communication control unit causes the communication unit to receive data specified by the instruction accepted by the accepting unit among the plurality of pieces of data stored in the server from the server. The storage control unit causes the storage unit to store the data received by the communication unit from the server. Through communications with the server or through communications with another of the information processing devices, the storage control unit performs processes to: (i) identify the other information processing device storing data identical to the data received from the server and stored in the storage unit; and (ii) delete the data from the storage unit when the data is deleted in the identified other information processing device.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

FIG. 1 illustrates a schematic configuration of an information processing system according to Embodiment 1 of the disclosure;

FIG. 2 illustrates an internal configuration of an information processing device according to Embodiment 1;

FIG. 3 illustrates an outline of process content in the information processing system according to Embodiment 1;

FIG. 4 illustrates an example of an operation screen displayed in a display of the information processing device according to Embodiment 1;

FIG. 5 illustrates a flow of operations of the information processing device according to Embodiment 1;

FIG. 6 illustrates an example of information stored in a storage unit in the information processing device according to Embodiment 1;

FIG. 7 illustrates an example of changes in data stored in the storage unit in the information processing device according to Embodiment 1;

FIG. 8 illustrates a flow of operations of an information processing device according to Embodiment 2 of the disclosure;

FIG. 9 illustrates an example of changes in data stored in a storage unit in the information processing device according to Embodiment 2;

FIG. 10 illustrates a flow of operations of an information processing device according to Embodiment 3 of the disclosure;

FIG. 11 illustrates an example of changes in data stored in a storage unit in the information processing device according to Embodiment 3;

FIGS. 12A to 12C illustrate examples of data stored in a storage unit in a server according to Embodiment 4 of the disclosure;

FIG. 13 illustrates a flow of operations of an information processing device and the server according to Embodiment 4;

FIG. 14 illustrates an example of an operation screen displayed in a display of the information processing device according to Embodiment 4;

FIG. 15 illustrates a flow of operations of an information processing device according to Embodiment 5 of the disclosure;

FIG. 16 illustrates an example of an operation screen displayed in a display of the information processing device according to Embodiment 5;

FIG. 17 illustrates an example of data stored in a server according to Embodiment 5;

FIGS. 18A and 18B illustrate outlines of operations of an information processing device and a server according to Embodiment 6 of the disclosure;

FIG. 19 illustrates a flow of operations of the information processing device and the server according to Embodiment 6;

FIG. 20 illustrates an example of information stored in a storage unit in the information processing device according to Embodiment 6;

FIG. 21 illustrates a flow of operations of an information processing device and a server according to Embodiment 7 of the disclosure;

FIG. 22 illustrates an example of associated information preliminary stored in a storage unit in a server according to Embodiment 7;

FIG. 23 illustrates an example of an operation screen displayed in a display of the information processing device according to Embodiment 7; and

FIG. 24 illustrates an example of associated information preliminary stored in a storage unit in a server according to a supplement of Embodiment 7.

### DETAILED DESCRIPTION

Example apparatuses are described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

The following describes an information processing device, an information processing system, and an information processing method according to one embodiment of the disclosure with reference to the drawings.

### Embodiment 1

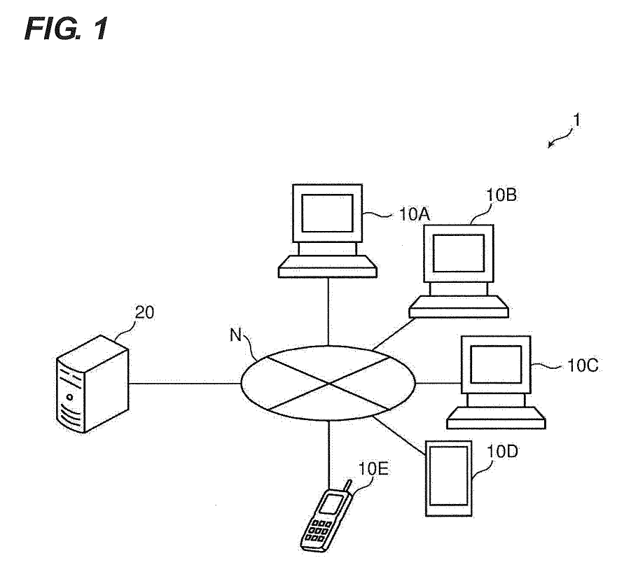

FIG. 1 illustrates a schematic configuration of an information processing system according to Embodiment 1 of the disclosure. An information processing system 1 is constituted of a plurality of information processing devices such as a PC 10A, a PC 10B, a PC 10C, a smart phone 10D, and a portable terminal 10E; and a server 20 connected to these information processing devices over a network N such as a LAN and a Wide Area Network (WAN). While the example illustrated in FIG. 1 illustrates only the one server, two or more servers may be connected to the network N. The PC 10A, the PC 10B, the PC 10C, the smart phone 10D, and the portable terminal 10E are all examples of the information processing devices including a storage unit, a controller, and a similar unit described later, and unless otherwise specifically distinguished, the following collectively describes these devices as an information processing device 10.

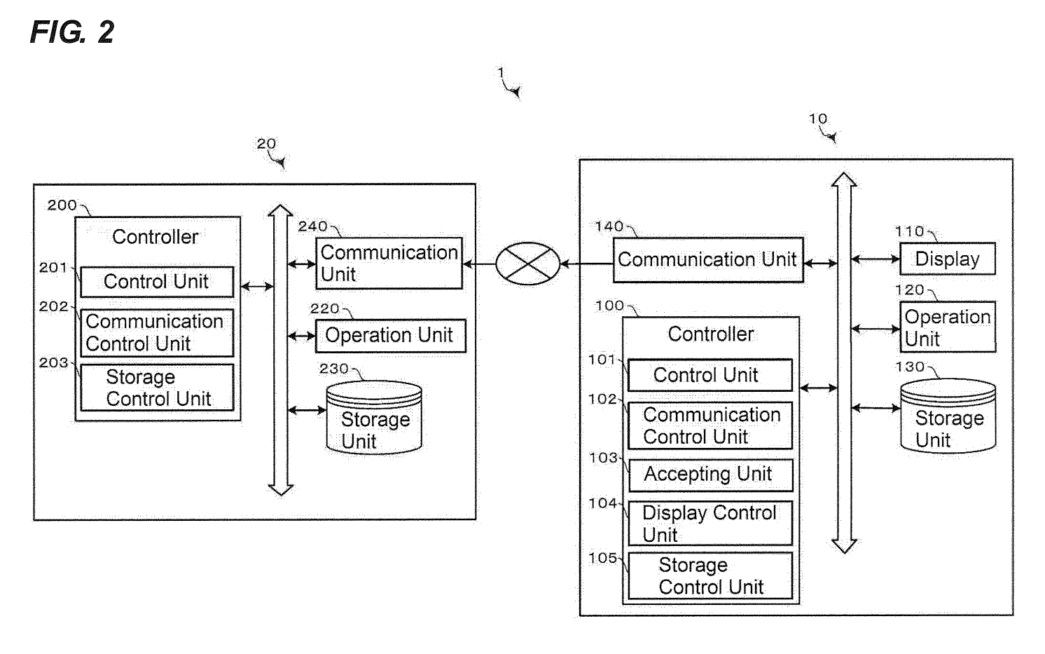

FIG. 2 illustrates an internal configuration of the information processing device 10. The information processing device 10 includes, for example, a display 110, an operation unit 120, a storage unit 130, a communication unit 140, and a controller 100.

The display 110 is constituted including a liquid crystal display (LCD) and an organic EL (OLED) display. The display 110 displays various operation screens or a similar screen under a display control by a display control unit described later.

The operation unit 120 is an input unit such as a computer mouse, a keyboard, and a touch panel located at a front surface of the display 110. Instructions of various operations and processes executable by the information processing device 10 from a user are input using the operation unit 120 such as the computer mouse, the keyboard, and the touch panel.

The storage unit 130 is a storage device such as a HDD and a flash memory. The storage unit 130 includes a plurality of storage regions, and the respective storage regions store various pieces of data. In this embodiment, the storage unit 130 includes a plurality of directories such as a route directory and a subdirectory at a lower layer of this route directory as the plurality of storage regions.

The communication unit 140 is a communication interface including a communication module such as a LAN chip. With this communication unit 140, the information processing device 10 can communicate with the server 20 connected over the network N.

The controller 100 is constituted including a processing unit, a Random Access Memory (RAM), a Read Only Memory (ROM), and a dedicated hardware circuit. The processing unit is, for example, a Central Processing Unit (CPU), a Field Programmable Gate Array (FPGA), and an Application Specific Integrated Circuit (ASIC). Operations by the processing unit following an Operating System (OS) stored (installed) in the storage unit 130 and a program such as various control programs cause the controller 100 to function as a control unit 101, a communication control unit 102, an accepting unit 103, a display control unit 104, and a storage control unit 105. Note that the respective configurations may be configured by hardware circuits, not by the operation following the program by the controller 100.

The accepting unit 103 has a function that receives a signal output from the operation unit 120 and accepts the instruction from the user input using the operation unit 120.

The control unit 101 manages the entire control of the information processing device 10. Especially, the control unit 101 has a function of executing various programs such as word-processing software and spreadsheet software stored in the storage unit 130 according to the instruction accepted by the accepting unit 103.

The display control unit 104 has a function of controlling a display operation by the display 110 and causes the display 110 to display an operation screen showing an information processing result by the control unit 101 or a similar screen.

For example, when the accepting unit 103 accepts a pressing operation of an icon associated with document data displayed in the display 110, the control unit 101 executes a program for word-processing software. The display control unit 104 causes the display 110 to display an operation screen showing the document data associated with the icon as the execution result of the word-processing software.

The communication control unit 102 has a function of controlling a communication operation of data by the communication unit 140. Especially, the communication control unit 102 causes the communication unit 140 to receive data specified by the instruction accepted by the accepting unit 103 among the plurality of pieces of data stored in the server 20 from the server 20.

The storage control unit 105 has a function of controlling a storage operation of data by the storage unit 130. Especially, the storage control unit 105 causes the storage unit 130 to store the data received by the communication unit 140 from the server 20 and performs a storage control of data created or changed by the control unit 101.

Subsequently, the following describes a configuration of the server 20. The server 20 includes, for example, a controller 200, an operation unit 220, a storage unit 230, and a communication unit 240. The operation unit 220 is an input unit such as a computer mouse, a keyboard, and a touch panel located at a front surface of a display. The storage unit 230 is a storage device such as a HDD and a flash memory. The communication unit 240 is a communication interface including a communication module such as a LAN chip. The server 20 may include the display constituted of, for example, a liquid crystal display and an organic EL display.

The controller 200 is constituted including a processing unit, a RAM, a ROM, and a dedicated hardware circuit. An operation by the processing unit following a program stored in the storage unit 230 causes the controller 200 to function as a control unit 201, a communication control unit 202, and a storage control unit 203. Note that the respective configurations may be configured by hardware circuits, not by the operation following the program by the controller 200.

The control unit 201 manages the entire operation control of the server 20. The communication control unit 202 has a function of controlling a communication operation of data by the communication unit 240. The storage control unit 203 has a function of controlling a storage operation by the storage unit 230.

The configuration of the information processing system 1 has been described above. Subsequently, the following describes process content in the information processing system 1 constituted of the information processing device 10 and the server 20.

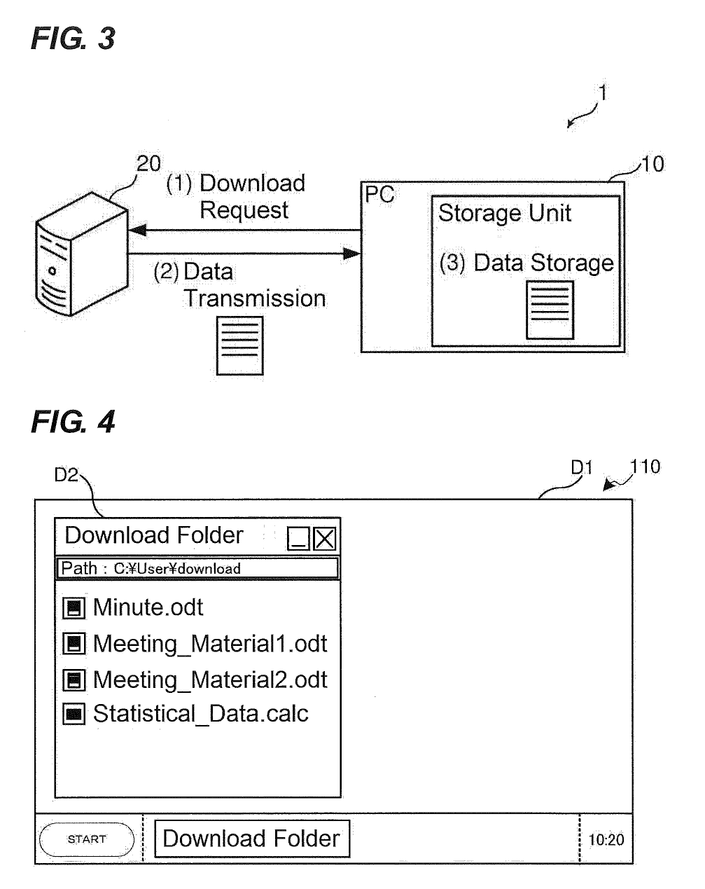

FIG. 3 illustrates an outline of the process content in the information processing system 1. As indicated by (1) in this drawing, the communication control unit 102 in the information processing device 10 causes the communication unit 140 to transmit a download request that specifies the data shown by the instruction accepted by the accepting unit 103 to the server 20. Next, as indicated by (2) in FIG. 3, the communication control unit 202 in the server 20 causes the communication unit 240 to transmit the data specified by the download request among the data stored in the storage unit 230 to the information processing device 10. As indicated by (3) in FIG. 3, the storage control unit 105 in the information processing device 10 causes the storage unit 130 to store the data transmitted from the server 20 and received by the communication unit 140. In this respect, the storage control unit 105 causes a storage region (a directory) in the storage unit 130 shown by the instruction accepted by the accepting unit 103 to internally store the data.

FIG. 4 illustrates an example of an operation screen displayed in the display 110. FIG. 4 illustrates the operation screen displayed in the display 110 when the control unit 101 executes file browser software stored in the storage unit 130. The example illustrated in FIG. 4 displays an operation screen D2 as a process result of the file browser software in a desktop screen D1. The operation screen D2 shows a path indicative of a position of the directory in the storage unit 130, “C¥User¥download”, and a plurality of icons associated with various pieces of data (files) contained in this directory.

A download folder illustrated in FIG. 4 stores the data received (downloaded) from the server 20. When the storage of the data downloaded from the server 20 is completed, the display 110 displays the icon associated with this downloaded data under the control by the display control unit 104. When the accepting unit 103 accepts a deletion instruction of data and the data is deleted from the storage unit 130 under the control by the storage control unit 105, the icon associated with this deleted data is deleted from the operation screen D2 under the control by the display control unit 104.

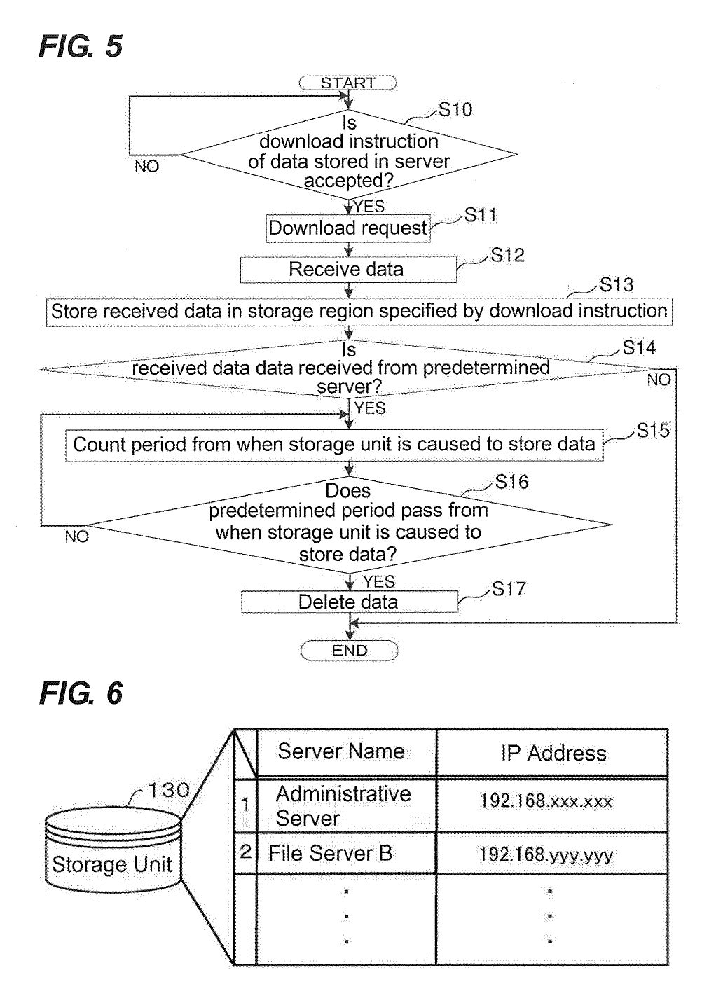

The following further describes the process content in the information processing device 10 in detail using a flowchart illustrated in FIG. 5. When the accepting unit 103 accepts a download instruction of data stored in the server 20 (YES at Step S10), the communication control unit 102 causes the communication unit 140 to transmit the download request to the server 20 (Step S11). Next, the communication control unit 102 causes the communication unit 140 to receive the data transmitted from the server 20 (Step S12). Then, the storage control unit 105 causes a storage region in the storage unit 130 shown by the instruction accepted by the accepting unit 103 to internally store the data received by the communication unit 140 at the process of Step S12 (Step S13).

After the process of Step S13, the storage control unit 105 determines whether the data received by the communication unit 140 at the process of Step S12 is the data received from the predetermined server 20 or not (Step S14). Here, as illustrated in FIG. 6, the storage unit 130 preliminary stores information indicative of the predetermined server 20. In the example illustrated in FIG. 6, the information indicative of the predetermined server 20 is constituted of a server name and an IP address, information to identify this predetermined server 20 on the network N. The storage control unit 105 performs the process of Step S14 with reference to the information stored in the storage unit 130.

When the data received by the communication unit 140 is not the data received from the predetermined server 20 (NO at Step S14), the information processing device 10 ends the process. On the other hand, when the data received by the communication unit 140 is the data received from the predetermined server 20 (YES at Step S14), the storage control unit 105 performs the following processes of Step S15 to Step S17.

At the process of Step S15, a period from a time point at which the storage control unit 105 causes the storage unit 130 to store the data downloaded from the server 20 is counted. When this counted period reaches a predetermined period or more (YES at Step S16), the storage control unit 105 performs a process to delete the data from the storage unit 130 (Step S17).

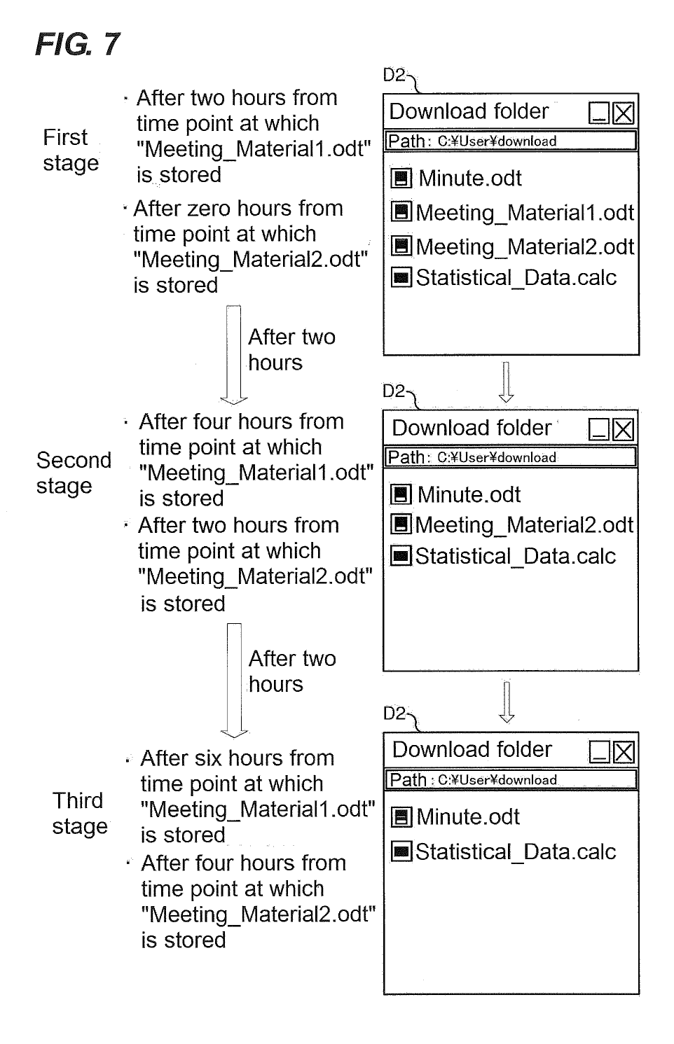

FIG. 7 illustrates an example of changes in data stored in the storage unit 130. The first stage in the drawing illustrates the operation screen D2 at a time point at which “Meeting_Material2.odt” is stored in the storage unit 130. Two hours before the time point at which the storage unit 130 stores this “Meeting_Material2.odt,” the storage unit 130 stores “Meeting_Material1.odt.”

The second stage in FIG. 7 illustrates a state where two hours has passed from the state illustrated in the first stage. In this state, four hours, a predetermined period, has passed from the time point at which the storage unit 130 stores “Meeting_Material1.odt.” Since four hours, which is the predetermined period, has passed from the time point at which the storage unit 130 stores “Meeting_Material1.odt,” the storage control unit 105 deletes “Meeting_Material1.odt” from the storage unit 130. As this result, the icon associated with “Meeting_Material1.odt” is deleted from the operation screen D2.

The third stage in FIG. 7 illustrates a state where two hours has additionally passed from the state illustrated in the second stage. In this state, four hours, the predetermined period, has passed from the time point at which the storage unit 130 stores “Meeting_Material2.odt.” Since four hours, which is the predetermined period, has passed from the time point at which the storage unit 130 stores “Meeting_Material2.odt,” the storage control unit 105 deletes “Meeting_Material2.odt” from the storage unit 130. As this result, the icon associated with “Meeting_Material2.odt” is deleted from the operation screen D2.

Here, the meeting material or a similar material possibly becomes data unnecessary for the individuals after an end of the meeting. A configuration such that the predetermined server 20 stores such data not permanently important for the individuals and the data is downloaded from the respective information processing devices 10 connected to the network N deletes this data from the storage unit 130 after the predetermined period passes. This makes it possible to delete the data on the information processing device 10 side without awareness by the individual when the data downloaded from the server 20 to the individual information processing device 10 becomes not so important. Even when the data is deleted from the individual information processing device 10, since the server 20 keeps storing this data, the data can be downloaded again from the server 20 as necessary.

### Embodiment 2

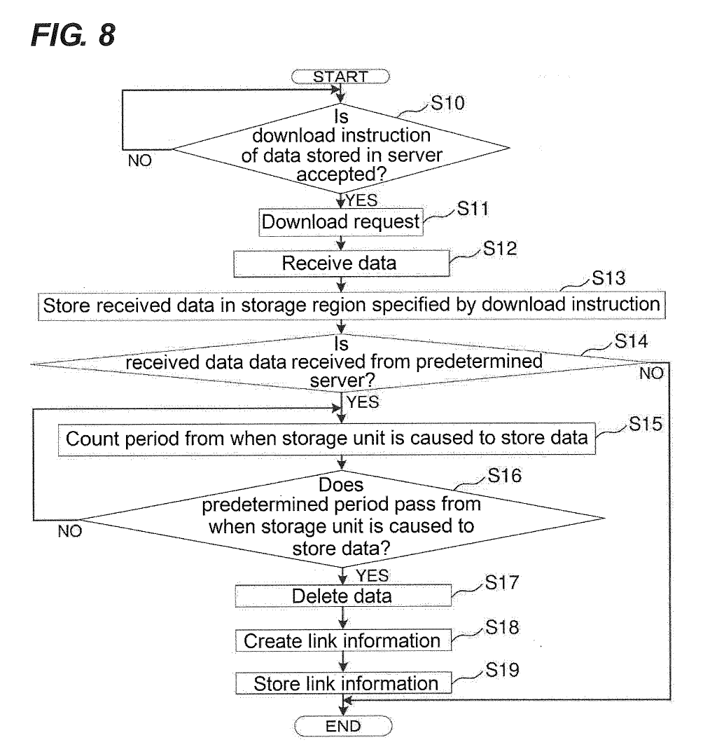

FIG. 8 illustrates a flow of operations by the information processing device 10 according to Embodiment 2. Like reference numerals designate processes of identical content to the flowchart illustrated in FIG. 5, and therefore such processes will not be further elaborated here.

The information processing device 10 according to Embodiment 2 executes processes of Step S18 and Step S19 after the data deletion process at Step S17.

At the process of Step S18, the storage control unit 105 creates link information with which data identical to the data deleted from the storage unit 130 and stored in the server 20 can be accessed. Here, the link information is, for example, information such as a shortcut and a hyperlink including a Uniform Resource Locator (URL) indicative of the position of the server 20 with which the position of the server 20 on the network N and the storage position of the data in the server 20 can be identified. At the process of Step S19, the storage control unit 105 causes the storage region that has stored the deleted data in the storage unit 130 to store the link information.

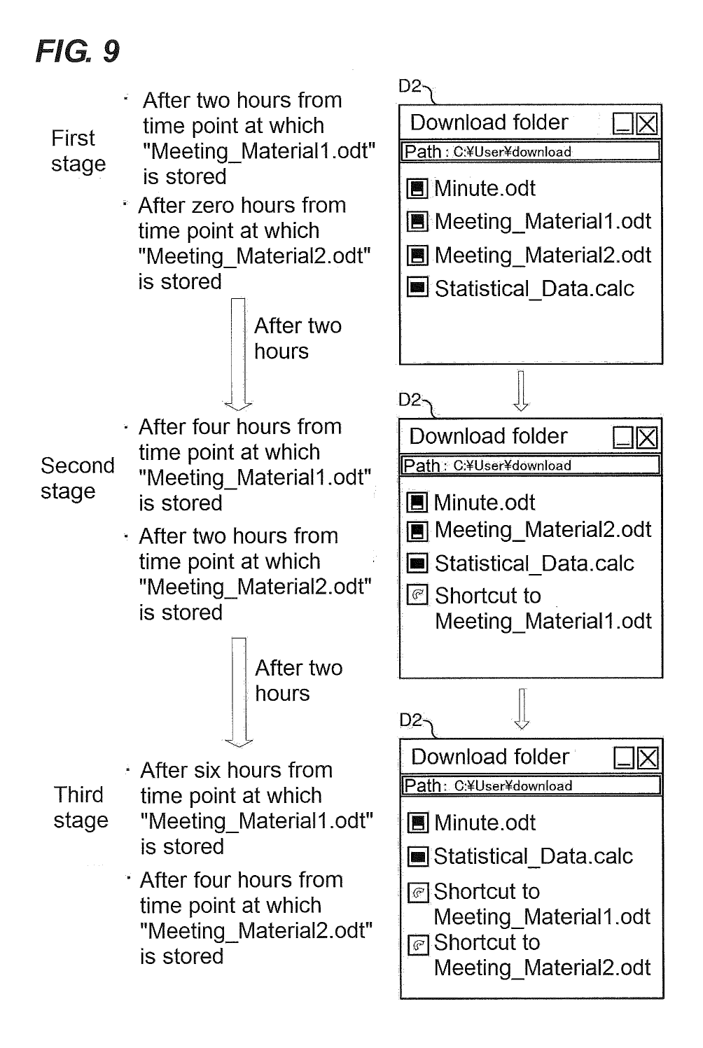

FIG. 9 illustrates an example of changes in data stored in the storage unit 130. As illustrated in the second stage in the drawing, when the data of “Meeting_Material1.odt” is deleted from the storage unit 130, the link information (the shortcut) with which the data of “Meeting_Material1.odt” in the server 20 can be accessed is created at the storage position identical to the deleted data. Additionally, as illustrated in the third stage in the drawing, when the data of “Meeting_Material2.odt” is deleted from the storage unit 130, the link information with which the data of “Meeting_Material2.odt” in the server 20 can be accessed is created at the storage position identical to the deleted data.

As described above, the information processing device 10 according to Embodiment 2 of the disclosure can easily access the original data on the individual server 20 even after the data downloaded from the server 20 is deleted from the individual information processing device 10.

### Embodiment 3

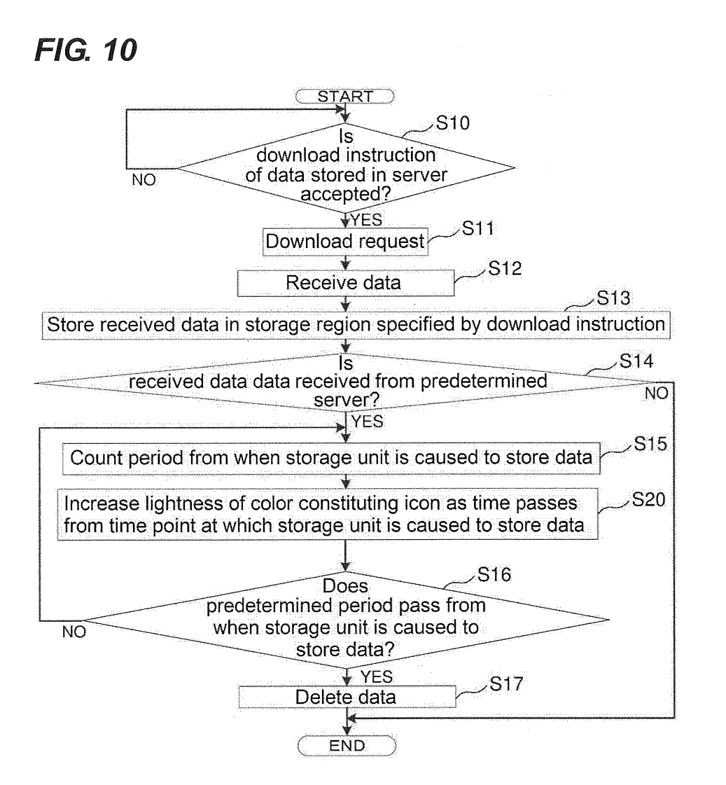

FIG. 10 illustrates a flow of operations of the information processing device 10 according to Embodiment 3. Like reference numerals designate processes of identical content to the flowchart illustrated in FIG. 5, and therefore such processes will not be further elaborated here.

With the information processing device 10 according to of Embodiment 3, after a process of counting a period from when the data at Step S15 is stored in the storage unit 130, the display control unit 104 changes a display form of the icons associated with this data displayed in the display 110 as the time passes from the time point at which the storage unit 130 stores the data (Step S20).

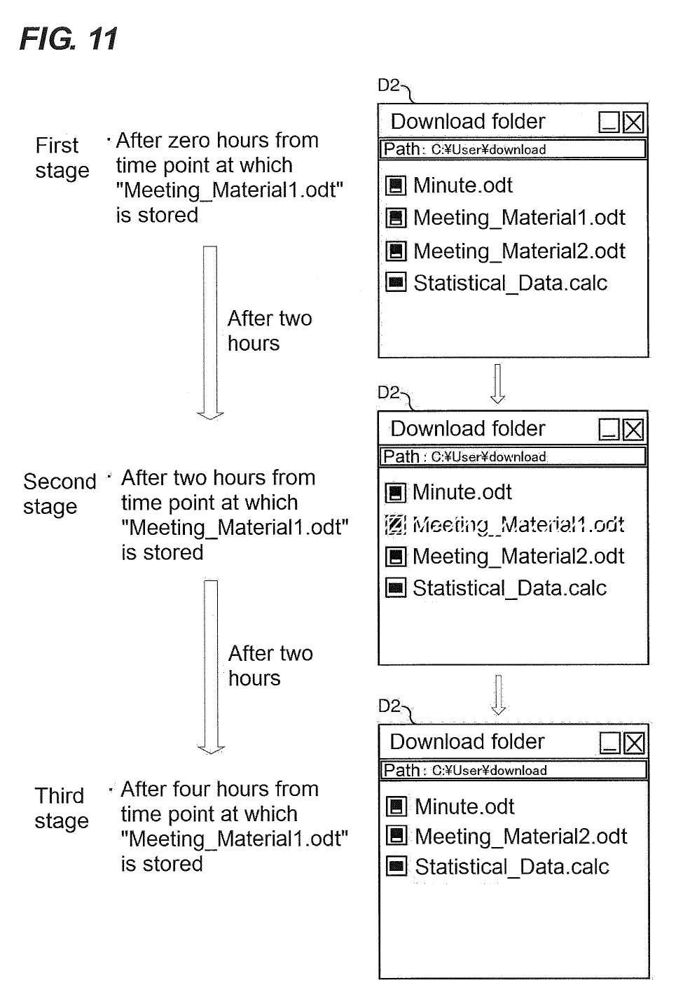

FIG. 11 illustrates an example of changes in data stored in the storage unit 130. The first stage in the drawing illustrates the operation screen D2 at a time point at which “Meeting_Material1.odt” is stored in the storage unit 130. The second stage in the drawing illustrates a state where two hours has passed from the state illustrated in the first stage. In this state, as indicated by the dotted lines in the drawing, the display control unit 104 increases lightness of a color constituting the icon associated with “Meeting_Material1.odt” more than the state illustrated in the first stage in the drawing. The third stage in the drawing is in the state where two hours has additionally passed from the state illustrated in the second stage and four hours, which is the predetermined period, has passed from the time point at which the storage unit 130 stores “Meeting_Material1.odt.” From the storage unit 130, “Meeting_Material1.odt” is deleted and the icon associated with “Meeting_Material1.odt” is also deleted on the operation screen D2.

As described above, the example increases the lightness of the color constituting the icon as the time passes from the time point at which the data is stored in the storage unit 130 to change the display form of the icon. This ensures notifying the user of an approximate period until the data is deleted. The display control unit 104 may change the display form of the icon by decreasing the size of the icon as the time passes from the time point at which the data is stored in the storage unit 130.

When the accepting unit 103 accepts a predetermined operation (for example, double click) on the icon, the display control unit 104 may perform a process to return the display form of the icon to the display form at the time point at which the data is stored in the storage unit 130. In this case, the storage control unit 105 returns the period counted at Step S15 to 0. Thus, the data is deleted from the storage unit 130 when the predetermined period passes after the predetermined operation is performed, not when the predetermined period passes from the time point at which the data is stored in the storage unit 130. In view of this, the execution of the predetermined operation by the user ensures extending the period until the data is deleted.

### Embodiment 4

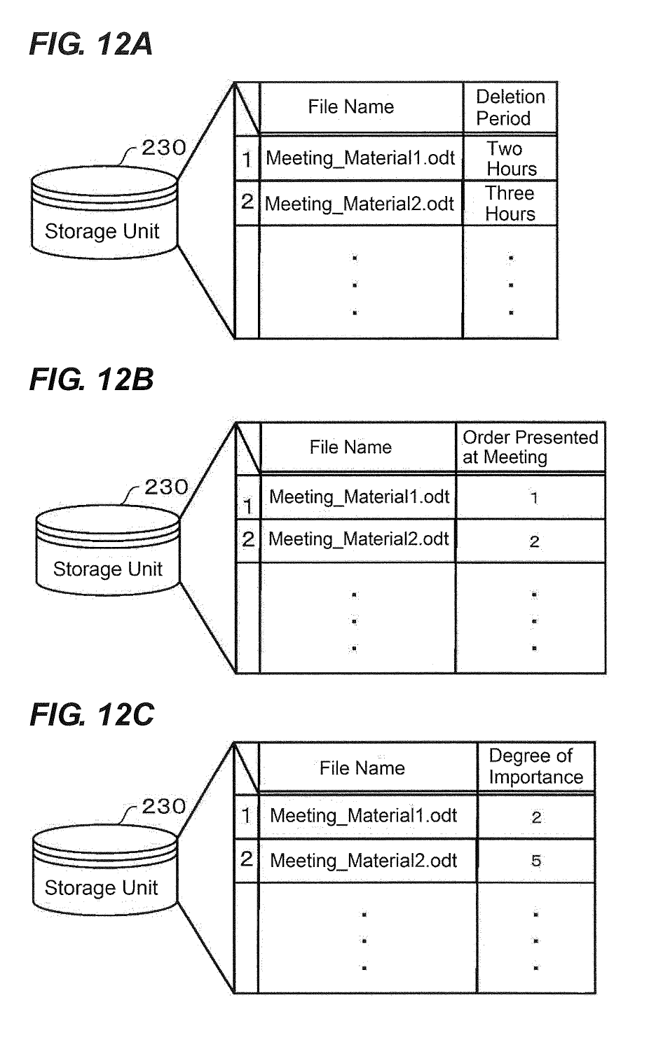

FIGS. 12A to 12C illustrate examples of data stored in the storage unit 230 in the server 20 according to Embodiment 4. In Embodiment 4, the storage unit 230 in the server 20 stores information to determine a deletion period of data associated with the data. In the example illustrated in FIG. 12A, the storage unit 230 stores a name of data and the deletion period of this data for each data. In the example illustrated in FIG. 12B, the storage unit 230 stores the name of data and an order of this data presented at a meeting for each data. In the example illustrated in FIG. 12C, the storage unit 230 stores a name of data and information indicative of a degree of importance of this data for each data. Together with the data, the information is transmitted from the server 20 to the information processing device 10 and the information processing device 10 determines the deletion period of data based on the transmitted information.

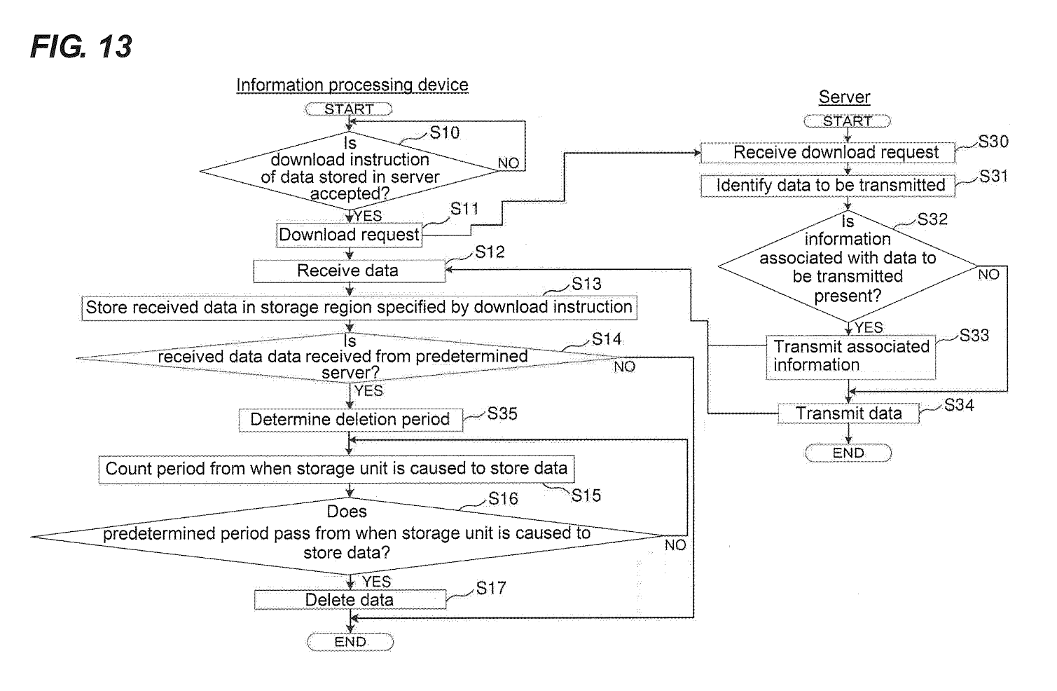

FIG. 13 illustrates a flow of operations of the information processing device 10 and the server 20 according to Embodiment 4. Like reference numerals designate processes of identical content to the flowchart illustrated in FIG. 5, and therefore such processes will not be further elaborated here.

When the communication unit 240 in the server 20 receives the download request transmitted from the information processing device 10 (Step S30), the communication control unit 202 in the server 20 identifies data target for transmission shown by the download request (Step S31). When the information associated with the identified data is present (YES at S32), the communication control unit 202 in the server 20 causes the communication unit 240 to transmit the information associated with this data together with the data (Steps S33 and S34). On the other hand, when the information associated with the identified data is absent (NO at Step S32), the communication control unit 202 in the server 20 causes the communication unit 240 to transmit only the identified data (Step S34).

When the information is associated with the transmitted data, that is, when the server 20 transmits the information together with the data, the storage control unit 105 in the information processing device 10 performs a process to determine the deletion period of data based on the information received by the communication unit 140 (Step S35).

For example, when the information indicative of the degree of importance of the data as illustrated in FIG. 12C is transmitted from the server 20, the storage control unit 105 in the information processing device 10 determines a period becoming longer as the degree of importance indicated by this information becomes high as the deletion period of data. Alternatively, when the information indicative of the deletion period of data as illustrated in FIG. 12A is transmitted from the server 20, the storage control unit 105 in the information processing device 10 determines the period indicated by this information as the deletion period of data. When the information indicative of the order of data presented at the meeting as illustrated in FIG. 12B is transmitted from the server 20, the storage control unit 105 in the information processing device 10 determines a period becoming longer as the order indicated by this information becomes later as the deletion period of data.

As described above, the information processing device 10 and the server 20 according to Embodiment 4 of the disclosure can differentiate the deletion periods for each data stored in the server 20 and can delete the data from the storage unit 130 at the deletion period appropriate for the data.

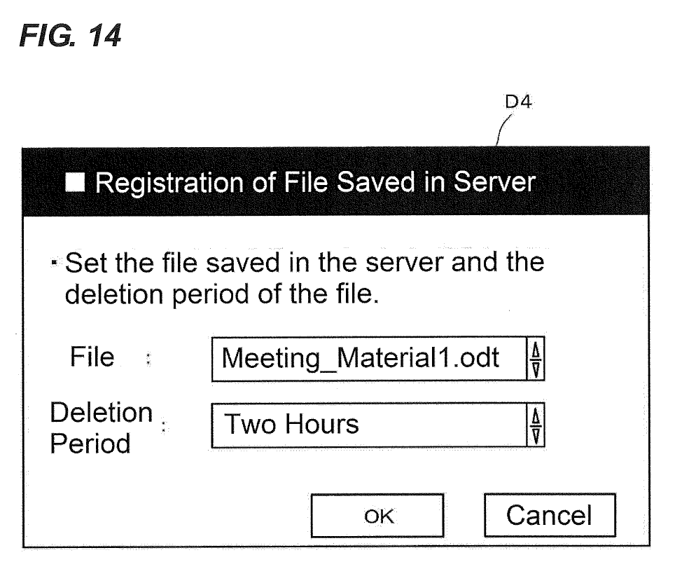

The information processing device 10 may display an operation screen D4 as illustrated in FIG. 14 in the display 110 under the control by the display control unit 104. The storage control unit 105 creates information to determine the deletion period of data in this operation screen based on the operation accepted by the accepting unit 103. Then, the communication control unit 102 transmits this created information to the server 20 and causes the storage unit 230 in the server 20 to store the information. This ensures determining the period at which the data stored in the server 20 is deleted on the information processing device 10 side.

### Embodiment 5

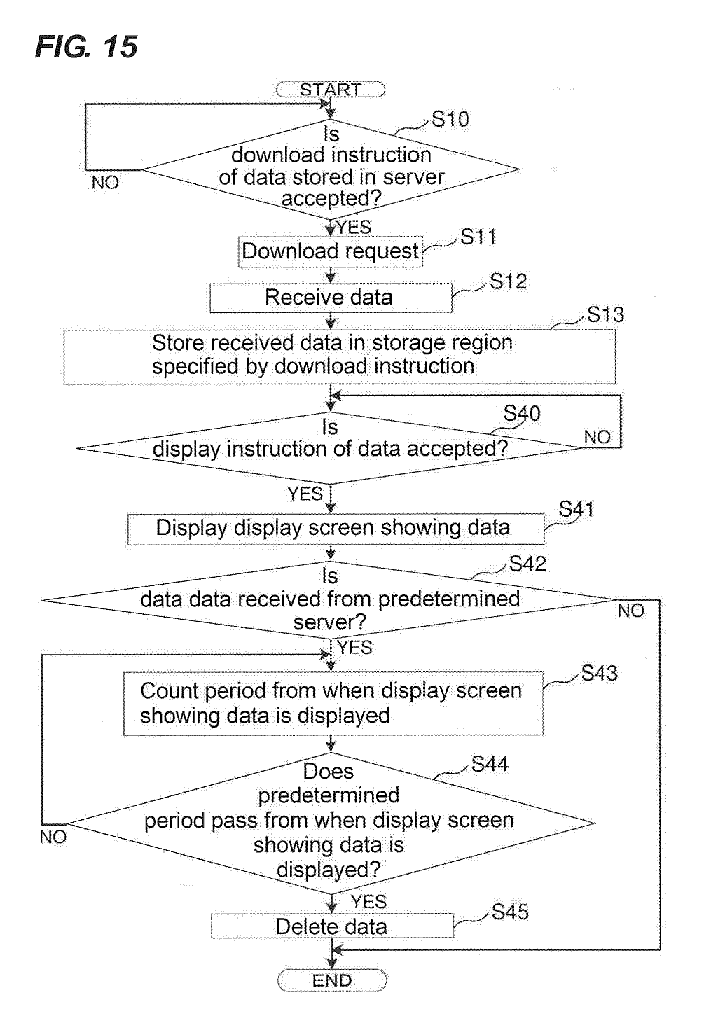

FIG. 15 illustrates a flow of operations by the information processing device 10 according to Embodiment 5. Like reference numerals designate processes of identical content to the flowchart illustrated in FIG. 5, and therefore such processes will not be further elaborated here.

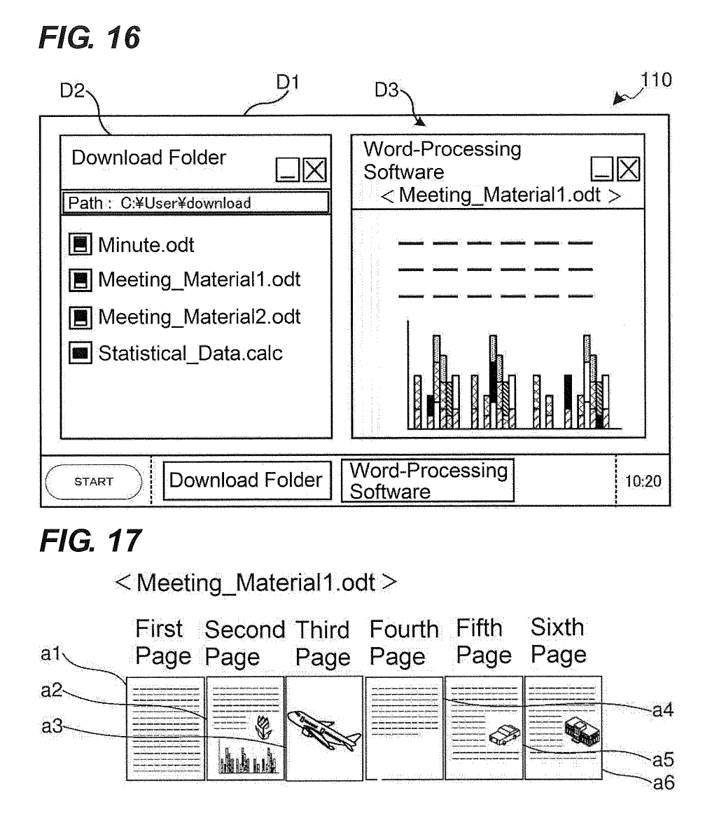

After the process of Step S13, when the accepting unit 103 accepts a display instruction of data of the data stored in the storage unit 130 at the process of Step S13 (YES at Step S40), the display control unit 104 causes the display 110 to display a display screen showing this data (Step S41). In the example illustrated in FIG. 16, a selection operation of the icon associated with“Meeting_Material1.odt” displays a display screen D3 showing the data of “Meeting_Material1.odt” in the display 110.

When the data displayed at the process of Step S41 is data received from the predetermined server 20 (YES at Step S42), the storage control unit 105 counts a period from the time point at which the display 110 displays the display screen showing the data (Step S43). Then, when this counted period reaches a predetermined period or more (YES at Step S44), the storage control unit 105 performs a process to delete the data from the storage unit 130 (Step S45).

As described above, since the information processing device 10 according to Embodiment 5 of the disclosure deletes the data at the timing at which the predetermined period passes from the time point of the user browsing the data, a situation where the data is deleted without the user browsing the downloaded data at all can be avoided.

### Supplement 1

Since the display 110 has the limited size, there may be a case where all content of data cannot be displayed at a time. In this case, as illustrated in FIG. 16, the display 110 displays the display screen showing a part of the content of data. The storage control unit 105 may count a period from the time point at which the display 110 displays the display screen showing a predetermined part of content of this data, not counting the period from the time point at which the display 110 displays the display screen simply showing the data like the process of Step S43.

That is, the storage control unit 105 performs a process to identify whether the data shown in the display screen includes a predetermined part of the data or not. Specifically, the storage control unit 105 determines whether the data shown in the display screen contains predetermined characters (such as “summary” and “conclusion”) or not. When the data contains these predetermined characters, the storage control unit 105 identifies that the data shown in the display screen contains a predetermined part of the data. Further, the storage control unit 105 determines whether the data shown in the display screen contains image data or not. When the data contains the image data, the storage control unit 105 may identify that the data shown in the display screen includes a predetermined part of the data.

The process can delete the data at the timing at which the predetermined period passes from the time point of the user browsing an important part in the data, not the time point at which the user simply browses the data.

### Supplement 2

As illustrated in FIG. 17, there may be a case where the data that the server 20 stores is constituted of a plurality of pages. In the example illustrated in the drawing, the data of “Meeting_Material1.odt” is constituted of six pages, from a1 to a6.

In this case, the storage control unit 105 performs a process to identify a page including predetermined characters in a plurality of pages constituting the data as a predetermined part of the data. For example, when the page a5 in the drawing contains the predetermined characters such as “summary” and “conclusion,” the storage control unit 105 deletes the data from the storage unit 130 at the timing at which the predetermined period passes from the time point of the display 110 displaying the page a5.

The storage control unit 105 may identify a page containing equal to or more than the predetermined number of characters among the plurality of pages constituting the data as a predetermined part of data. Since a page with the large number of characters has a higher possibility of a page describing important content, the process can delete the data at the timing at which the predetermined period passes from the time point of the user browsing the important part in the data.

The storage control unit 105, not deleting the data from the storage unit 130 at the timing at which the predetermined period passes from the time point of the display 110 displaying the page containing the predetermined characters and the page containing the characters equal to or more than the predetermined number of characters identified as the predetermined part of data, but may delete the data from the storage unit 130 when a state of the display 110 displaying this page continues for equal to or more than a predetermined period. This ensures deleting the data when the user browses the important part in the data for equal to or more than a certain period.

Additionally, the storage control unit 105 may delete the data from the storage unit 130 when the predetermined period passes from the time point at which the display 110 displays all pages constituting the data. This ensures avoiding a situation where the data is deleted from the storage unit 130 while the user browses only some pages constituting the data.

### Supplement 3

The storage control unit 105 may count a sum of the periods during which the display 110 displays the display screen showing the page identified by the processes described in Supplement 1 and Supplement 2 and delete the data from the storage unit 130 when this sum of the counted periods reaches equal to or more than the predetermined period. The user browses various pages through scrolling (switching) the pages shown in the display screen. In this respect, by performing the process, the data can be deleted at a timing at which a total browsing period of the page important in the data reaches equal to or more than the predetermined period while the user browses the various pages.

### Supplement 4

When the predetermined period passes from the time point at which the display 110 displays the display screen showing one or a plurality of pages identified by the processes described in Supplement 1 and Supplement 2, the storage control unit 105 may delete this identified one or plurality of pages in the data constituted of the plurality of pages stored in the storage unit 130, not deleting the data itself from the storage unit 130. That is, the storage control unit 105 performs a process of changing the data constituted of the plurality of pages stored in the storage unit 130 to the data from which the identified one or plurality of pages are removed from these plurality of pages.

### Embodiment 6

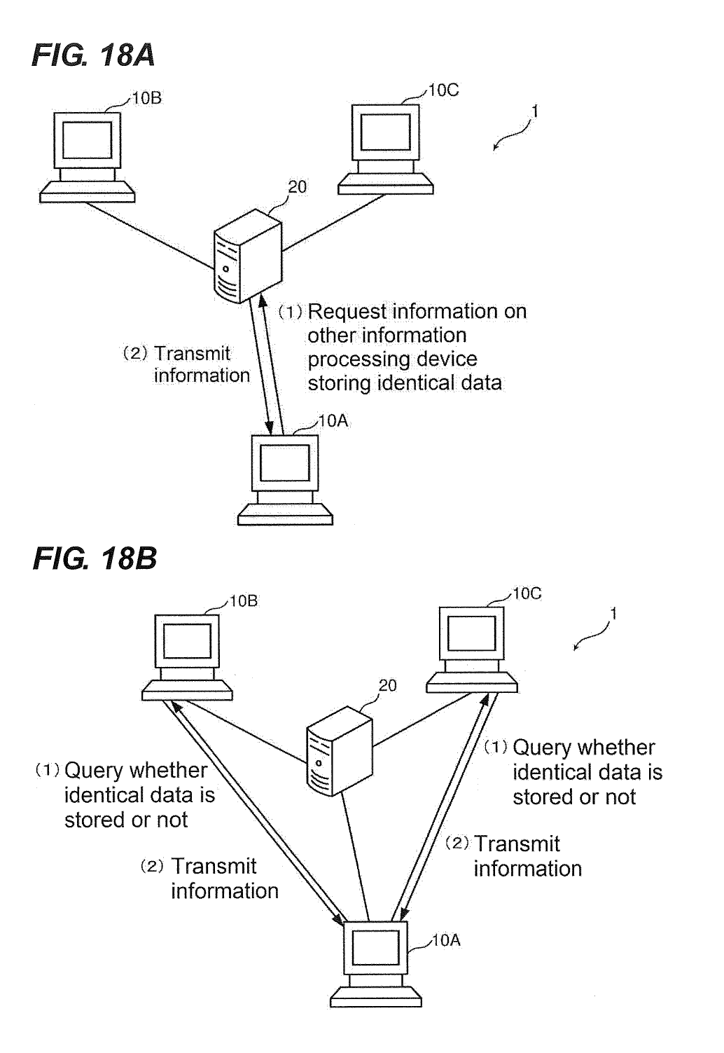

FIGS. 18A and 18B illustrate outlines of operations of the information processing device 10 and the server 20 according to Embodiment 6. As illustrated in these drawings, the storage control unit 105 performs a process, through communications with the server 20 or through communications with other information processing devices 10, to identify the information processing device 10 storing data identical to data received from the server 20 and stored in the storage unit 130.

FIG. 18A illustrates the case where the storage control unit 105 communicates with the server 20 and identifies the other information processing device 10 storing the data identical to the data received from the server 20 and stored in the storage unit 130. Specifically, the information processing device 10 requests information on the other information processing device 10 storing the identical data to the server 20, and the server 20 side creates this information and transmits this information to the information processing device 10.

Meanwhile, FIG. 18B describes the case of performing a process to identify the other information processing device 10 storing the data identical to the data received from the server 20 and stored in the storage unit 130 through communications with the other information processing device 10. Specifically, the information processing device 10 performs a process of communicating with the plurality of respective other information processing devices 10 connected to the network N and querying whether the identical data is stored or not.

The information processing device 10 according to Embodiment 5 performs the process to identify the other information processing device 10 storing the identical data by the method illustrated in FIG. 18A or FIG. 18B and performs the process to delete this data from the storage unit 130 when the data is deleted in this identified other information processing device 10.

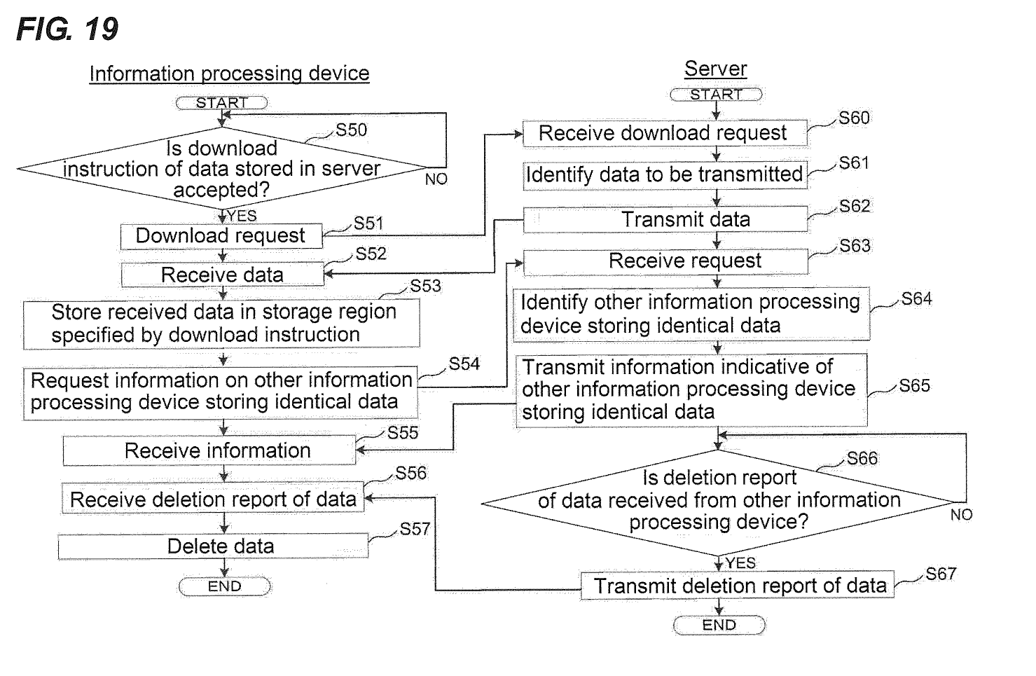

FIG. 19 illustrates a flow of operations to identify the other information processing device 10 storing the identical data by the method illustrated in FIG. 18A in detail. When the accepting unit 103 accepts the download instruction of the data stored in the server 20 (YES at Step S50), the communication control unit 102 causes the communication unit 140 to transmit the download request to the server 20 (Step S51).

When the communication unit 240 in the server 20 receives the download request transmitted from the information processing device 10 (Step S60), the communication control unit 202 in the server 20 identifies the data target for transmission indicated by the download request (Step S61) and causes the communication unit 240 to transmit this identified data (Step S62).

Next, the communication control unit 102 in the information processing device 10 causes the communication unit 140 to receive the data transmitted from the server 20 (Step S52). Then, the storage control unit 105 causes a storage region in the storage unit 130 shown by the instruction accepted by the accepting unit 103 to internally store the data received by the communication unit 140 at the process of Step S52 (Step S53).

After the process of Step S53, the communication control unit 102 causes the communication unit 140 to transmit a signal requesting the information on the other information processing device 10 storing the identical data (Step S54). When the server 20 receives the signal indicative of this request (Step S63), the communication control unit 202 in the server 20 communicates with the plurality of information processing devices 10 connected to the server 20 to identify the other information processing device 10 storing the identical data (Step S64). Then, the communication control unit 202 in the server 20 causes the communication unit 240 to transmit the information indicative of this identified information processing device (Step S65).

After the process of Step S65, the information indicative of the deletion of this data in the other information processing device 10 storing the identical data is transmitted from the other information processing device 10. When the server 20 receives this information (YES at Step S66), the communication control unit 202 in the server 20 causes the communication unit 240 to transmit a deletion report of data (Step S67).

On the other hand, when the information processing device 10 receives the information transmitted at the process of Step S65 and the information transmitted at the process of Step S66 (Steps S55 and S56), the storage control unit 105 in the information processing device 10 performs a process to delete the data from the storage unit 130 (Step S57).

As described above, the information processing device 10 and the server 20 according to Embodiment 6 of the disclosure, when the identical data is deleted at the other information processing device 10 connected to the network N, this data can be deleted from the information processing device 10 without awareness by the individuals.

There may be a case where the data identical to the data downloaded from the server to one PC of the individual is also downloaded to another PC. When this data is deleted in the other PC storing this identical data, the one PC and the other PC from which this data is deleted coexist while this data is kept stored on the network. However, in terms of data management, the PCs connected to the identical network preferably have the consistent data storage state (whether the data is kept stored or the data is deleted) in some cases, and the embodiment can achieve such preferable data management.

### Supplement 1

When there are the plurality of other information processing devices 10 storing the data identical to the data received from the server 20 and stored in the storage unit 130, the storage control unit 105 may delete this data from the storage unit 130 when the data is deleted in the other information processing devices 10 by equal to or more than a predetermined proportion among these plurality of other information processing devices 10. For example, with the five other information processing devices 10 storing the identical data, when the data is deleted in 50% or more, which is the predetermined proportion, of the information processing devices 10 (for example, three), the storage control unit 105 deletes this data from the storage unit 130.

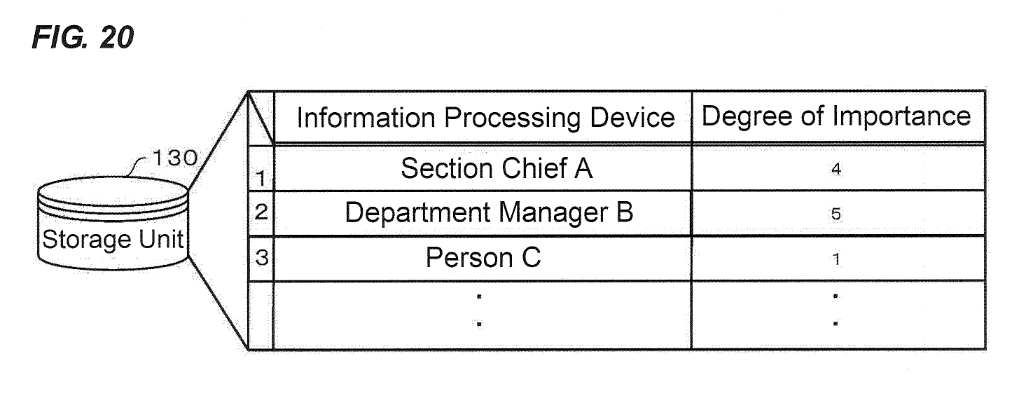

Alternatively, the storage unit 130 in the information processing device 10 or the storage unit 230 in the server 20 may preliminary store scores indicative of the degrees of importance of these plurality of respective information processing devices 10 that can transmit/receive the data to/from the server 20. FIG. 20 illustrates one example of the information stored in the storage unit 130 in the information processing device 10. In the example illustrated in the drawing, the names of the information processing devices 10 and the scores indicative of the degrees of importance of the information processing devices 10 are stored for the plurality of respective information processing devices 10 connected to the server 20.

The storage control unit 105 performs a process to combine the scores of the other information processing devices 10 where the data is deleted and delete the data from the storage unit 130 when this combined value becomes equal to or more than a predetermined value. This ensures the deletion of the data from the information processing device 10 when the identical data is deleted from the information processing device 10 with the high degree of importance among the other information processing devices 10 connected to the network N.

### Supplement 2

The storage control unit 105 may create link information with which data identical to the data deleted from the storage unit 130 and stored in the server 20 can be accessed and store this created link information in the storage region in which the deleted data has been stored in the storage unit 130. Accordingly, even when the data downloaded from the server 20 is deleted from the individual information processing device 10, the individual can easily access the original data on the server 20 after that.

### Embodiment 7

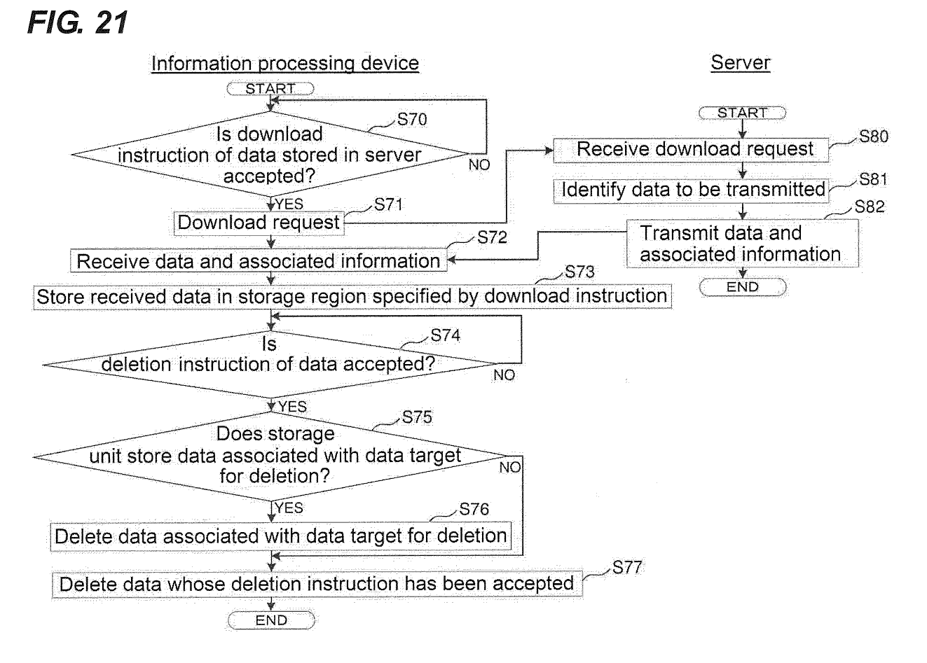

FIG. 21 illustrates a flow of operations of the information processing device 10 and the server 20 according to Embodiment 7. When the accepting unit 103 accepts the download instruction of the data stored in the server 20 (YES at Step S70), the communication control unit 102 causes the communication unit 140 to transmit the download request to the server 20 (Step S71). In addition to the information identifying the data target for download, this download request includes a command that the associated information stored in the server 20 is to be transmitted together with the data.

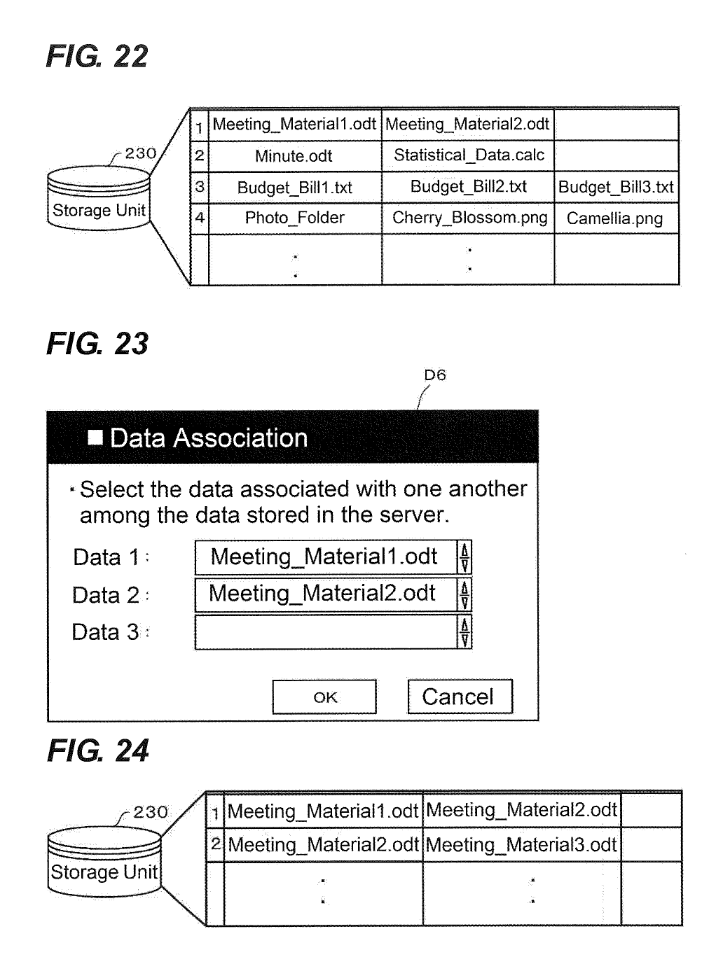

FIG. 22 illustrates one example of the associated information preliminary stored in the storage unit 230 in the server 20. The associated information is information indicative of data mutually associated with the plurality of pieces of data stored in the server 20. In the drawing, for example, the data of “Meeting_Material1.odt” and the data of “Meeting_Material2.odt” in the server 20 are associated.

When the communication unit 240 in the server 20 receives the download request transmitted from the information processing device 10 (Step S80), the communication control unit 202 in the server 20 identifies data target for transmission shown by the download request (Step S81). The communication control unit 202 in the server 20 causes the communication unit 240 to transmit the associated information stored in the storage unit 230 together with this identified the data (Step S82).

The communication control unit 102 in the information processing device 10 causes the communication unit 140 to receive the data and the associated information transmitted from the server 20 (Step S72). Then, the storage control unit 105 causes a storage region in the storage unit 130 shown by the instruction accepted by the accepting unit 103 to internally store the data received by the communication unit 140 at the process of Step S72 (Step S73).

After the process of Step S73, when the accepting unit 103 accepts the deletion instruction of data downloaded from the server 20 (YES at Step S74), the storage control unit 105 in the information processing device 10 performs a process to determine whether the data associated with the data target for deletion is stored in the storage unit 130 or not based on the associated information received at the process of Step S72 (Step S75). When the data associated with the data target for deletion is stored (YES at Step S75), the storage control unit 105 deletes the data associated with the data whose deletion instruction has been accepted from the storage unit 130 together with the data whose deletion instruction has been accepted (Steps S76 and S77). On the other hand, when the data associated with the data target for deletion is not stored (NO at Step S75), the storage control unit 105 deletes only the data whose deletion instruction has been accepted from the storage unit 130 (Step S77).

As described above, with the information processing device 10 and the server 20 according to Embodiment 7 of the disclosure, when the plurality of pieces of data are downloaded from the server 20, only inputting the instruction to delete only one of the associated data can also delete the other related data from the storage unit 130. Additionally, this also ensures avoiding a situation where the other data is forgotten to be deleted while only the one related data is deleted.

### Supplement 1

The storage control unit 203 in the server 20 may identify two or more pieces of data in which identical character strings are present by equal to or more than a predetermined amount through analysis of the plurality of pieces of stored data, create the associated information that defines these two or more pieces of identified data as the data associated with one another, and cause the storage unit 230 to store this created associated information. Since the data in which the identical character strings are present by equal to or more than the predetermined amount has a high possibility of being the data describing content related to one another, performing the process ensures the data association on the server 20 side.

The information processing device 10 may display an operation screen D6 as illustrated in FIG. 23 in the display 110 under the control by the display control unit 104. The storage control unit 105 identifies the two or more pieces of data associated with one another among the plurality of pieces of data stored in the server 20 based on the operation accepted by the accepting unit 103 in this operation screen D6. Then, the communication control unit 102 causes the communication unit 140 to transmit the information indicative of the two or more pieces of associated data identified by the storage control unit 105 to the server 20. The server 20 creates the associated information based on the information transmitted from the information processing device 10. Accordingly, the desired data can be associated in the information processing device 10.

### Supplement 2

The storage control unit 105 in the information processing device 10 may perform a process to identify whether the server 20 stores the data to be deleted or not before performing the process to delete the data at Steps S76 and S77 in FIG. 21 from the storage unit 130. Specifically, by communications with the server 20 via the communication unit 140 under the control by the communication control unit 102 in the information processing device 10, whether the server 20 stores the data to be deleted or not is identified.

When the data to be deleted is deleted from the server 20, the storage control unit 105 does not perform the process to delete the data from the storage unit 130. On the other hand, when the server 20 stores the data to be deleted, the storage control unit 105 performs a process to delete the data from the storage unit 130 (Steps S76 and S77). The process can avoid the situation where the data is deleted from the information processing device 10 as well in the state of deleting the data from the server 20, falling to access the data.

### Supplement 3

There may be a case where the data received by the communication unit 140 from the server 20 and stored in the storage unit 130 is data in a directory stored in the server 20. In this case, the communication control unit 102 in the information processing device 10 may perform a process to determine whether the data in the directory is updated or added or not in the server 20 at every predetermined period. Specifically, the determination process is performed through communications with the server 20 via the communication unit 140. When the data in the directory stored in the server 20 is updated or added, the communication control unit 102 causes the communication unit 140 to receive this updated or added data from the server 20. Afterwards, the storage control unit 105 causes the storage unit 130 to store the updated or added data received by the communication unit 140 from the server 20.

The process ensures reflecting the data updated or added in the server 20 after downloading the data to the inside of the information processing device 10 without the awareness by the individuals.

### Supplement 4

FIG. 24 illustrates an example of the associated information preliminary stored in the storage unit 230 in the server 20 in the example illustrated in Supplement 4. In the example illustrated in the drawing, the data of “Meeting_Material1.odt” and “Meeting_Material3.odt” are associated with only the data of “Meeting_Material2.odt.” On the other hand, the data of “Meeting_Material2.odt” is associated with both data of “Meeting_Material1.odt” and “Meeting_Material3.odt.”

When the plurality of pieces of data associated with one piece of data whose deletion instruction has been accepted by the accepting unit 103 are present in the storage unit 130, the storage control unit 105 performs a process to delete the plurality of pieces of associated data from the storage unit 130 together with this one piece of data. For example, when the accepting unit 103 accepts the deletion instruction of the data of “Meeting_Material2.odt,” the storage control unit 105 deletes the data of “Meeting_Material1.odt” and “Meeting_Material3.odt” from the storage unit 130 together with the data of “Meeting_Material2.odt.” On the other hand, when the accepting unit 103 accepts the deletion instruction of the data of “Meeting_Material1.odt” or “Meeting_Material3.odt” associated with only the one piece of data, the storage control unit 105 deletes the data of “Meeting_Material2.odt” together with the data of “Meeting_Material1.odt” or “Meeting_Material3.odt” from the storage unit 130.

Various modifications are possible for the disclosure not limited to the configurations of the embodiments.

The programs described in the embodiments and the modifications may be recorded in a computer-readable non-transitory recording medium such as a hard disk, a CD-ROM, a DVD-ROM, and a semiconductor memory.

The configurations described in the embodiments and the modifications may be partially combined.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. An information processing system comprising:
a server that stores a plurality of pieces of data; and
an information processing device that includes a communication unit configured to perform transmission and reception of data with the server,
wherein the server further stores associated information, the associated information being indicative of data mutually associated between the plurality of pieces of data,
the information processing device further includes:
an accepting unit that accepts an instruction from a user;
a communication control unit that controls a communication operation of the data by the communication unit, the communication control unit causing the communication unit to receive data specified by the instruction accepted by the accepting unit among the plurality of pieces of data stored in the server from the server;
a storage unit; and
a storage control unit that causes the storage unit to store the data received by the communication unit from the server, and
the storage control unit performs processes to:
(i) cause the communication unit to receive the associated information from the server in addition to the data when the communication unit is caused to receive the data from the server; and
(ii) determine whether the storage unit stores data associated with one piece of data or not when the accepting unit accepts a deletion instruction of data specifying the one piece of data stored in the storage unit and delete the associated data from the storage unit together with the one piece of data when the storage unit stores the associated data.

2. The information processing system according to claim 1,
wherein the server identifies two or more pieces of data in which identical character strings are present by equal to or more than a predetermined amount through analysis of the plurality of pieces of stored data, the server creating the associated information that defines the two or more pieces of identified data as data associated with one another.

3. The information processing system according to claim 1,
wherein the storage control unit identifies two or more pieces of data associated with one another among the plurality of pieces of data stored in the server based on the instruction from the user,
the communication control unit causes the communication unit to transmit information indicative of the two or more pieces of data associated with one another identified by the storage control unit to the server, and
the server creates the associated information based on the information transmitted from the communication unit.

4. The information processing system according to claim 1,
wherein when a plurality of pieces of data associated with the one piece of data are present in the storage unit, the storage control unit performs a process to delete the plurality of pieces of associated data from the storage unit together with the one piece of data.

5. The information processing system according to claim 1,
wherein the storage control unit performs a process to identify whether the server stores the data to be deleted or not before performing a process to delete the data from the storage unit, the storage control unit not performing the process to delete the data from the storage unit when the data to be deleted has been deleted from the server, the storage control unit performing the process to delete the data from the storage unit when the server stores the data to be deleted.

6. The information processing system according to claim 1,
wherein after the data is deleted from the storage unit, the storage control unit creates link information with which the data stored in the server becomes accessible, the storage control unit causing a storage region that has stored the data among a plurality of storage regions in the storage unit to store the created link information.

7. The information processing system according to claim 1,
wherein the communication control unit performs a process to determine whether data in a directory is updated or added or not at every predetermined period when the data received by the communication unit from the server and stored in the storage unit is the data in the directory stored in the server, the communication control unit causing the communication unit to receive the updated or added data from the server when the data in the directory is updated or added, and
the storage control unit causes the storage unit to store the updated or added data received by the communication unit from the server.

8. An information processing device comprising:
a communication unit configured to perform transmission and reception of data with an external server, the external server storing a plurality of pieces of data, the server further storing associated information, the associated information being indicative of data mutually associated between the plurality of pieces of data;
an accepting unit that accepts an instruction from a user;
a communication control unit that controls a communication operation of the data by the communication unit, the communication control unit causing the communication unit to receive data specified by the instruction accepted by the accepting unit among the plurality of pieces of data stored in the server from the server;
a storage unit; and
a storage control unit that causes the storage unit to store the data received by the communication unit from the server,
wherein the storage control unit performs processes to:
(i) cause the communication unit to receive the associated information from the server in addition to the data when the communication unit is caused to receive the data from the server; and
(ii) determine whether the storage unit stores data associated with one piece of data or not when the accepting unit accepts a deletion instruction of data specifying the one piece of data stored in the storage unit and delete the associated data from the storage unit together with the one piece of data when the storage unit stores the associated data.

9. An information processing system comprising:
a server that stores a plurality of pieces of data; and
a plurality of information processing devices that include communication units configured to perform transmission and reception of data with the server,
wherein the plurality of information processing devices each further include:
an accepting unit that accepts an instruction from a user;
a communication control unit that controls a communication operation of the data by the communication unit, the communication control unit causing the communication unit to receive data specified by the instruction accepted by the accepting unit among the plurality of pieces of data stored in the server from the server;
a storage unit; and
a storage control unit that causes the storage unit to store the data received by the communication unit from the server, and
through communications with the server or through communications with another of the information processing devices, the storage control unit performs processes to:
(i) identify the other information processing device storing data identical to the data received from the server and stored in the storage unit; and
(ii) delete the data from the storage unit when the data is deleted in the identified other information processing device.

10. The information processing system according to claim 9,
wherein when there are the plurality of other information processing devices storing the data identical to the data received from the server and stored in the storage unit, the storage control unit performs a process to delete the data from the storage unit when the data is deleted in the other information processing device by equal to or more than a predetermined proportion among the plurality of other information processing devices.

11. The information processing system according to claim 9,
wherein the storage unit preliminary stores scores indicative of degrees of importance of the plurality of respective information processing devices configured to transmit/receive the data to/from the server; and
when there are the plurality of other information processing devices storing the data identical to the data received from the server and stored in the storage unit, the storage control unit performs a process to delete the data from the storage unit when a value found by combining the scores of the other information processing devices from which the data is deleted becomes equal to or more than a predetermined value.

12. The information processing system according to claim 9,
wherein after the data is deleted from the storage unit, the storage control unit creates link information with which the data stored in the server becomes accessible, the storage control unit causing a storage region that has stored the data among a plurality of storage regions in the storage unit to store the created link information.

13. An information processing device comprising:
a communication unit connected to an external server storing a plurality of pieces of data and another information processing device over a network, the communication unit being configured to perform transmission and reception of data with the external server and the other information processing device;
an accepting unit that accepts an instruction from a user;
a communication control unit that controls a communication operation of the data by the communication unit, the communication control unit causing the communication unit to receive data specified by the instruction accepted by the accepting unit among the plurality of pieces of data stored in the server from the server;
a storage unit; and
a storage control unit that causes the storage unit to store the data received by the communication unit from the server,
wherein through communications with the server or through communications with another of the information processing devices, the storage control unit performs processes to:
(i) identify the other information processing device storing data identical to the data received from the server and stored in the storage unit; and
(ii) delete the data from the storage unit when the data is deleted in the identified other information processing device.
